(19) United States
(12) Patent Application Publication
(10) Pub. No.: US 2010/0033496 A1
(43) Pub. Date: Feb. 11, 2010

(54) Methods and Storing Colour Pixel Data and Driving a Display, Means for Preforming Such Methods, and Display Apparatus Using the Same

(75) Inventor: Roberto Mancuso, Zurich (CH)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/090,685

(22) PCT Filed: Oct. 10, 2006
(86) PCT No.: PCT/IB2006/053721

§ 371 Date: Oct. 12, 2009

(30) Foreign Application Priority Data
Oct. 18, 2005 (EP) 05109694.9
Mar. 16, 2006 (EP) 06111244.7

(51) Int. Cl. G09G 5/36; G09G 5/02

(52) U.S. Cl. 345/604; 345/557

(57) ABSTRACT

A method of storing colour pixel data provides the pixel data in YUV form with a first number of bits per colour component. The number of bits of the U and V components of each pixel data element are reduced to provide modified YUV data, wherein the reduction in the number of bits is carried out for each pixel without reference to other pixel data. Data are stored in a form which retains independence between each pixel. This enables processing of the data in the memory in a simple manner, for example enabling individual pixel data to be changed, and simplifying image processing such as rotation and mirroring. The luminance information Y is preserved, and only the chrominance information is compressed. This can enable high quality to be maintained in greyscale images and in text images, whilst also providing a loss in colour resolution to natural colour images which may not be perceived by a user.

The present invention relates to methods of storing colour pixel data, and for during a display, means for carrying out such methods, and display apparatus using such.

The means for storing may be a display driver, and the display apparatus may be a flat panel display device, such as a liquid crystal display device, or a CRT display apparatus, and the like.

When storing pixel data, it is obviously desirable that the storage space required be kept to a minimum, while still retaining sufficient information to enable acceptable image display quality.

There are many applications where the compression of a colour image, comprising colour pixel data, is performed, and a number of compression methods are known. The compression algorithm used may be acceptable for some images in that the loss of quality which may result can be acceptable to a viewer. However, a compression method which provides satisfactory results for, for example, images with limited colour fluctuation between adjacent pixels, as in natural images, may perform unsatisfactorily with non-natural images, such as data graphics and text, and vice versa.

Natural images are often compressed by first converting them to the YUV domain, using a luminance and two chrominance (colour) components.

A compression algorithm may be used to compress an RGB image presented with, for example, 24 bits per pixel (colour triplet) into a memory with 18 bits per pixel, when the RGB image needs to be stored. To this end, it is possible to convert the image from the RGB domain, or format, to the YUV domain, or format, and then operate with a known algorithm, such as the so-called YUV 4:2:2 algorithm. Conversion of an RGB image to the YUV domain offers a limited compression ratio. Images are often stored in YUV format, allowing for individual processing of luminance and chroma information. The analog TV transmission standards also use the YUV domain where the bandwidth used for luminance transmission is significantly higher than that used for the chroma channels. Alternatively, it is possible to truncate the numbers of bits per component from, say, 8 to 6. Both techniques have advantages and disadvantages.

In the YUV 4:2:2 format, the chroma components are shared between two adjacent pixels and this gives a 33% reduction in the required storage area or bus band width compared with the YUV 4:4:4 format, while only a small reduction of the perceived image quality may be experienced by a viewer as the eye is typically less sensitive to colour changes over small distances.

The present invention provides methods of storing colour pixel data and driving a display which offer, or permit, improvements over the known methods.

According to one aspect of the present invention there is provided a method of storing colour pixel data, comprising:

providing the pixel data in YUV form with a first number of bits per colour component;

reducing the number of bits of the U and V components of each pixel data element to provide modified YUV data, wherein the reduction in the number of bits is carried out for each pixel without reference to other pixel data; and

storing the modified YUV data.

This method stores data in a form which retains independence between each pixel. This enables processing of the data in the memory in a simple manner, for example enabling individual pixel data to be changed, and simplifying image processing such as rotation and mirroring. The luminance information Y is preserved, and only the chrominance information is compressed. This can enable high quality to be maintained in greyscale images and in text images, whilst also providing a loss in colour resolution to natural colour images which may not be perceived by a user.

The method may further comprise receiving pixel data elements in RGB form, and converting the pixel data elements into the YUV form. Alternatively, the data can be received in YUV form. The original RGB data may have 8 bits per colour component per pixel, and the modified YUV data then has 5 bits for each of the U and V components and 8 bits for the Y component. This enables the memory device used to store the data to be reduced to 18 bits.

Storing the modified YUV data preferably comprises storing the data in a RAM which forms part of the driver circuitry of a colour display device. This is then used for image processing operations, for example enabling static images to be rendered with lower power consumption, or enabling image processing to be carried out, such as scrolling or partial scrolling. This may be of particular interest for small display devices, as used in portable electronic devices. The RAM may form part of an active matrix LCD driver circuit.

According to a second aspect of the invention, there is provided a method of driving a display, comprising:

reading pixel data from a memory in the form of YUV data, in which the Y component has a first number of bits, and the U and V components each have a second, lower, number of bits;

processing the U and V components of the pixels, and

for each pixel of at least one group of pixels:
if the U component value of that pixel meets a predetermined U criteria which takes into account the U component value for at least one other pixel, deriving at least one new U component value to replace the U component value of the pixel, the new U component value having a higher resolution than said U component value of the pixel; and
if the V component value of that pixel meets a predetermined V criteria which takes into account the V component value for at least one other pixel, deriving at least one new V component value to replace the V component value of the pixel, the new V component value having a higher resolution than said V component value of the pixel;

converting the resulting YUV values into RGB pixel drive data; and

driving the display using the RGB pixel drive data.

This method takes the reduced YUV data with full luminance component (of the first aspect of the invention) and derives the RGB pixel drive values. The replacement of U and V values with new values in the YUV domain before conversion to RGB space increases the number of colours that can be represented by the RGB pixel drive data. The new values represent with higher resolution may be obtained by an averaging process, and this averaging is only carried out when the averaging effect will not be perceived by the user, as determined by the difference criteria.

In a simplest implementation, the pixel data is processed as groups of pixels, each comprising an adjacent pair of pixels. In this case, the predetermined U criteria can be that the U component difference for the pair of pixels is below a threshold, in response to which an average U value is obtained for both pixels and the U component value for each pixel is replaced with the average U value. Similarly, the predetermined V criteria can be that the V component difference for the pair of pixels is below a threshold, in response to which an average V value is obtained for both pixels and the V component value for each pixel is replaced with the average V value.

This threshold operation ensures that the averaging of U or V values is not going to produce unwanted image artifacts.

Driving the display may comprise applying gamma correction using the RGB pixel drive data.

In one example, the first number is 8 and the second number is 5, so that 18 bit data is stored in memory. The RGB data is then 8 bits per pixel.

The invention also provides a driver arrangement for a display device comprising:

driver circuitry for providing signals to row and column conductors of the display device for driving the display;

a memory for storing pixel data in the form of YUV data, in which the Y component has a first number of bits, and the U and V components each have a second, lower, number of bits, wherein the stored pixel data for each pixel is independent of the stored pixel data for each other pixel; and

a processor for deriving RGB pixel drive data from the stored pixel data.

This driver arrangement includes a memory for storing pixel data in the format resulting from the method of the first aspect of the invention. The processor can then implement the drive method of the second aspect of the invention. In particular, the processor is preferably adapted to implement the method of the invention outlined above.

The invention also provides a display device comprising a driver arrangement of the invention, and an array of display pixels arranged in rows and columns.

The invention also provides a memory device which stores display device pixel data in the form of YUV data, in which the Y component has a first number of bits, and the U and V components each have a second, lower, number of bits, wherein the stored pixel data for each pixel is independent of the stored pixel data for each other pixel.

The invention also provides a computer program comprising code which when run on a computer is adapted to perform the methods of the invention.

Further features and advantages of the present invention will become apparent from reading the following description of preferred embodiments of the present invention, given by way of example only, and with reference to the accompanying drawings, in which:—

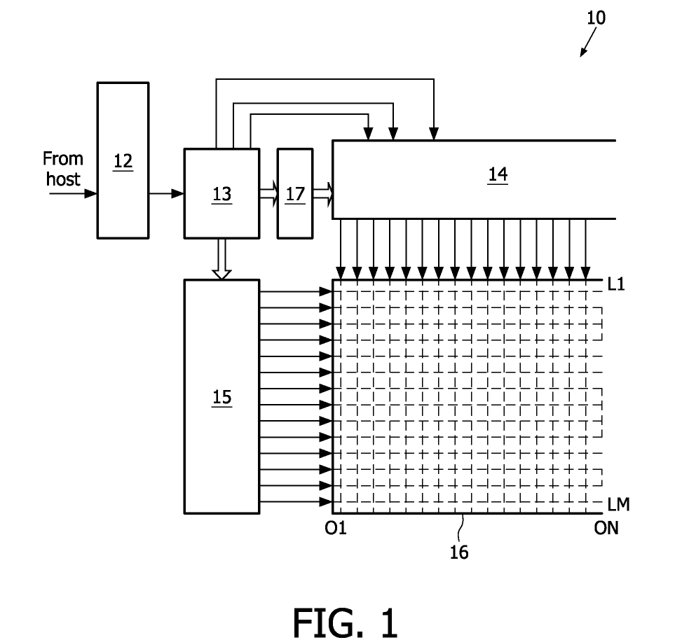

FIG. 1 is a schematic block diagram of an embodiment of display apparatus which utilises a method according to the present invention; and

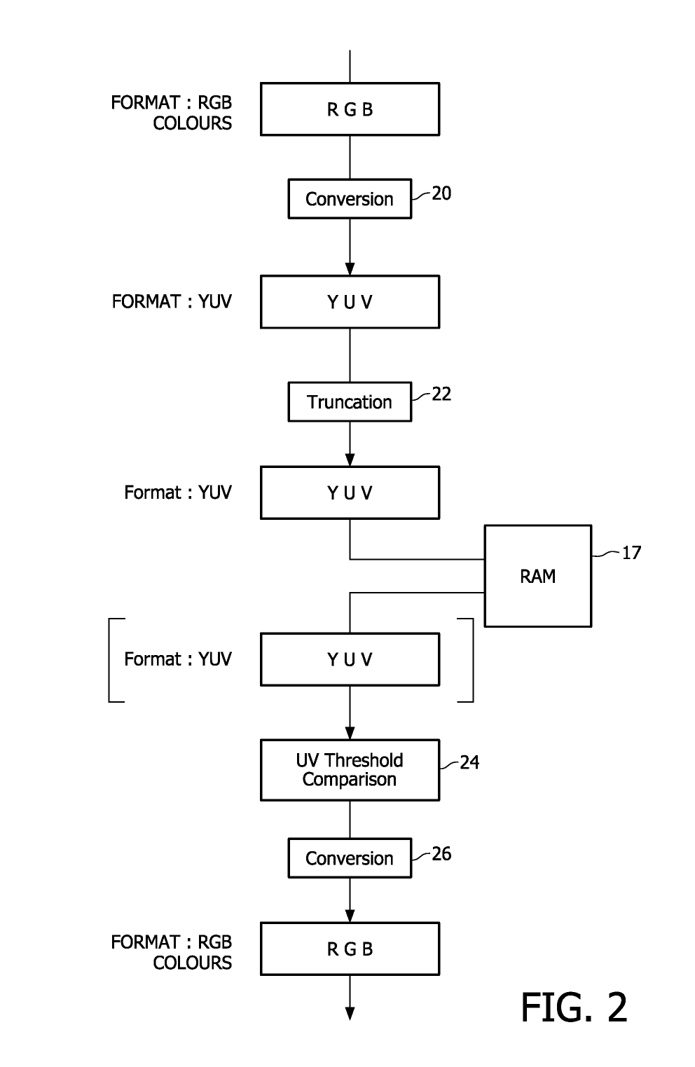

FIG. 2 is a schematic block diagram illustrating the principal operations of a preferred embodiment of method according to the invention; and

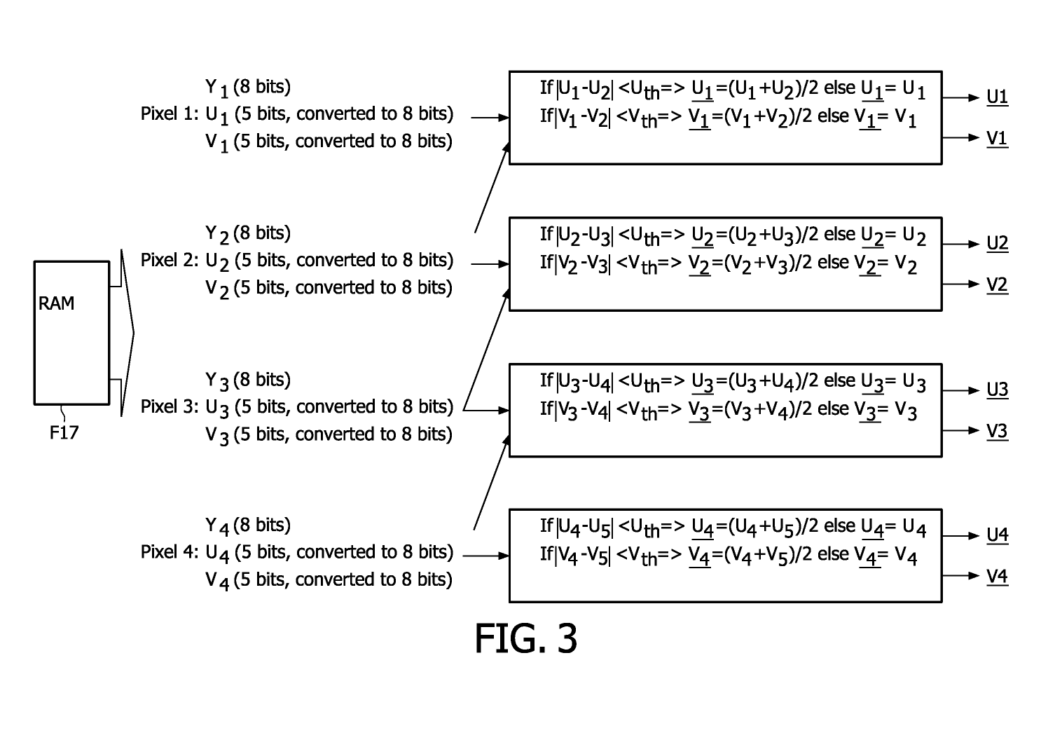

FIG. 3 shows an alternative algorithm for deriving new U and V component values.

Before describing the invention, it is considered useful to outline briefly two existing techniques, commonly known as “RGB Truncation” and “YUV 4:2:2” algorithms. For this, it is assumed that it is desired to reduce the number of bits per pixel (colour triplet) from 24 to 18.

For the RGB truncation algorithm, starting from a 24 bit RGB format, the 18 bit format is obtained by removing the two least significant bits for each colour component. Thus 1 pixel=24 bits=R₈ G₈ B₈ becomes after truncation 1 pixel=18 bits=R₆ G₆ B₆. The advantages of this technique are that the truncation does not damage text images, and the quality of natural images, or scenes, is not affected too much by the truncation, and that it is possible to write a single, individual, pixel into the storage device, for example RAM. Moreover, there are no limitations to writing or reading the RAM vertically or horizontally. There are, though, disadvantages in that the number of colours possible is reduced from 16 million to 262k, and the luminance and chrominance components loose the same amount of information.

For the YUV 4:2:2 technique, an image is compressed using an algorithm in the following manner. In the RGB domain

1 pixel=24 bits=R₈G₈B₈

and in the YUV domain

1 pixel=24 bits=Y₈U₈V₈

where Y is the luminance and U and V are the components of chrominance.

One example of known transformation matrix is:

Y=0.299*R+0.587*G+0.114*B

U=0.565*(B−Y)=0.5*B−0.169*R−0.331*G

V=0.713*(R−Y)=0.5*R−0.081*G−0.418*B

There are other transformation matrices that are used, for example including constant terms in addition to the R G B terms. However, the above transformation matrix is assumed for the purposes of this description.

The above transformation gives the YUV representation and it is referred to as YUV 4:4:4. The transformation is essentially without loss of information (a part is possibly lost due to limited number of bits due to the representation) and it still uses 24 bits per pixel. The way to reduce the pixel size is to use the YUV 4:2:2 transformation as follows.

Two adjacent pixels are defined as:

pixel1₁=Y₁U₁V₁ (24 BIT) pixel2=Y₂U₂V₂ (24 BIT)

Due to the human eye being capable of perceiving the luminance better than the chrominance, and typically being less sensitive to colour changes over short distance, the chrominance components of two neighbouring pixels are averaged:

U₁₂=(U₁+U₂)/(2)V₁₂=(V₁+V₂)/(2)

As consequence of this, the two pixels are represented as follows:

pixel1′=Y₁U₁₂V₁₂ and

pixel2′=Y₂U₁₂V₁₂

Thus, the two pixels need only 36 bits instead of 48, giving the desired 18 bits per pixel.

The advantage of this technique is that the image can be represented still with 16 million colours. Moreover, the luminance component is stored without any loss of information, and consequently for images having a gradation of greys, (grey scale), the transformation will not result in change in this respect.

The disadvantages, however, of this technique are that the quality of images having text can be poor and with many artifacts, because of the averaging of the colour information of neighbouring pixels. This reduction in quality is only avoided if the text uses only grey levels. It is also impossible to change a single pixel in the RAM, as pairs of pixels must share U and V data in order to provide the required reduction in data.

It is also extremely difficult to write the RAM horizontally and read it vertically and vice versa, and it is very difficult to implement image rotation. This is because of the dependency of data in one pixel on the data of a neighbouring pixel.

The present invention utilises a new algorithm, which for simplicity will be referred here to as the “YUV pixel based” algorithm. This YUV pixel based algorithm in effect merges the advantages of the above-described RGB truncation algorithm and YUV 4:2:2 algorithm, and offers the benefit of avoiding most of the disadvantages associated with these two known techniques.

Similar to the YUV 4:2:2 algorithm described above, the YUV pixel based algorithm of the invention uses the capability of the human eye to perceive better the luminance than the chrominance of image pixels. The human eye is capable of distinguishing between grey levels much better than a gradation of red, blue or green colours.

This YUV pixel based algorithm is developed for utilisation in display driver applications in particular, but could be used in any kind of graphic application, in software or hardware format, whenever a favourable compromise between fast software/hardware and a good image quality is required.

As the present invention primarily concerns the compression, storage and decompression of image data in a display driver, an example of a display module 10 and display driver circuitry will now be described briefly with reference to FIG. 1.

FIG. 1 shows a block diagram of a conventional (TFT) display module 10. Details of the electrical configuration for driving a simple matrix type liquid crystal panel 16 are illustrated. A plurality N of column electrodes (with N=384, for example) of the liquid crystal panel 16 are driven in parallel by a column driver bank 14 and a plurality of common row electrodes are driven by a row driver array 15 while being selected sequentially.

An interface 12 is used as the interface between a microcontroller 8 and the display module 10. The interface function 12 is typically realized at the input side of a display timing controller 13. The column driver bank 14 drives, as mentioned, the N columns of the LCD display 16 and it comprises N individual output buffers. The column driver bank 14 comprises an array of column drivers. Typically, each column driver of the column driver bank 14 serves N column electrodes of the display panel 16 by providing analog output signals.

The row driver array 15 comprises an array of row drivers. Each pixel of the display 16 is a switchable active matrix LC cell between a row and a column electrode. The display 16 may alternatively be a passive matrix LCD panel, organic LED panel, electrophoretic panel, or such like.

As illustrated in FIG. 1, there is a frame memory 17 located between the display timing controller 13 and the column driver bank 14. This frame memory 17 (typically a RAM) temporarily stores image data, in a manner in accordance with the present invention as will be described. Image data, which represent an image to be displayed on the liquid crystal panel 16, are given by the timing controller 13 via the frame memory 17 to the column driver 14 as serial data.

The output of the frame buffer 17, after having been decompressed on the fly, may be sent via a digital-to-analog converter to the column drivers inside the column driver bank 14. The data is transferred to the outputs of the column drivers in order to drive the display panel 16. Typically, a resistive DAC is employed as digital-to-analog converter. A resistive DAC is a resistor-based implementation of a digital-to analog converter which comprises a series of resistors (also referred to as a resistor divider chain).

As discussed above, the size of the frame memory (e.g. frame memory 17 in FIG. 1) is typically limited due to cost or other constraints. It is thus advantageous to provide for a compression of the image data, as described above, in order to reduce the storage area required.

The structure shown in FIG. 1 is conventional, but it may also be controlled in accordance with the invention, as described below. In particular, the invention changes the format of data stored in the memory 17, and also the process implemented by the microcontroller 8, both in writing data to the memory 17 and processing data read out from the memory 17.

The YUV pixel based algorithm of the invention comprises four steps. One example of implementation of the method of the invention will now be described with reference to FIG. 2. Two of the steps are performed initially to store the data into the RAM, for example display driver circuits for use in TV, monitors, or other display apparatus employing a flat panel display device such as active matrix liquid crystal display device, electroluminescent display device, or similar, or a CRT, and the third and the fourth steps are performed after reading the data from the RAM.

Step 1:

The “YUV pixel based” algorithm takes the RGB 24 bit representation of the pixel and translates it into the YUV domain (24 bits), for example using the ITU-R BT.601-5, SECTION 11 B (DIGITAL TELEVISION) recommendation. This transformation is shown as step 20. These recommendations use the following matrix (as also given above) to translate one pixel represented in the RGB domain (R₈G₈B₈) to 1 pixel in the YUV domain (Y₈U₈V₈):

Y=0.299*R+0.587*G+0.114*B

U=0.565*(B−Y)=0.5*B−0.169*R−0.331*G

V=0.713*(R−Y)=0.5*R−0.081*G−0.418*B

The Y value is the luminance component and the U and V are the chrominance components (also called colour difference components).

Step 2:

The “YUV pixel based” algorithm next carries out a truncation from 8 to 5 bits of the chrominance components, without any change in the luminance component. The new representation of the pixel (Y₈U₅V₅) can now be stored in the RAM. This is shown as step 22.

This truncation is carried out without reference to other pixel data, so that each pixel data value is independent of the other pixel values. As a result, individual pixel values can be modified, and the memory storage and readout operations can be carried out in simple manner. Furthermore, the manipulation of pixel data (such as image rotation) can be carried out easily.

Step 3:

In this example of the invention, when the pixel is read from the RAM, its chrominance components are compared with the chrominance components of the neighbouring pixel and, based on two programmable thresholds (Uₜₕ, Vₜₕ), these components could be merged together when the difference between them is below the threshold. This is shown as step 24.

As the comparison of neighbouring pixels is only carried out at the read out stage, manipulation of data in the memory can be carried out in advance, as mentioned above.

The use of the threshold makes it possible to keep unmerged the components that are quite different, as in the case of coloured text, and makes it possible to merge colours that are close to each other, as in the case of a gradient of colours. Assuming two adjacent pixels are defined as follows:

Pixel1=Y′₈U′₅V′₅

Pixel2=Y″₈U″₅V″₅

The threshold operation applies the following test:

If |U′₅−U″₅|<Uₜₕ then set U′″₈=(U′₅+U″₅)/2

If |V′₅−V″₅|<Vₜₕ then set V′″₈=(V′₅+V″₅)/2

Where Uₜₕ and Vₜₕ are the threshold levels set. It is noted that the averaging process shown as deriving an 8 bit value (which is then used for conversion to 8 bit RGB values), although of course the resolution is not increased from 5 bits to 8 bits by the averaging process.

The use of the threshold for the chrominance components results in three different combinations:

Case 1: both the U and V components are averaged:

Pixel1=Y′₈U′″₈V′″₈

Pixel2=Y″₈U′″₈V′″₈

Case 2: only the U component is averaged:

Pixel1=Y′₈U′₅V′″₈

Pixel2=Y″₈U″₅V′″₈

Case 3: only the V component is averaged:

Pixel1=Y′₈U′″₈V′₅

Pixel2=Y″₈U′″₈V″₅

Step 4:

Using the ITU-R BT.601-5 specification, the pixel represented in the YUV domain is converted back to the RGB domain. This is shown as step 26. The following matrix is used:

R=Y+1.402*V

G=Y−0.344*U−0.714*V

B=Y+1.772*U

The method of the invention enables text images to remain unchanged, which is an improvement compared to YUV 4:2:2, and equivalent to RGB truncation. Also, it is possible to write a single pixel into the RAM, an improvement again over YUV 4:2:2. The RAM can easily be horizontally and vertically written which, again, is an improvement over the YUV 4:2:2 transformation, and equivalent to RGB truncation.

The quality of natural images remains very high, at least equal to YUV 4:2:2 and RGB truncation. Due to the unmodified luminance component of the pixel, the grey scale remains unchanged, equivalent to YUV 4:2:2, and an improvement over RGB truncation.

Due to the fact that the truncation occurs only for the chrominance components and the fact that the human eye is less sensitive to chrominance than the luminance, the loss of colour is not readily visible.

The number of colours after step 4 goes down to around 550k, which is less than with YUV 4:2:2, but greater than with RGB truncation. However, visible artifacts are avoided because the YUV pixel based algorithm of the invention tends to cancel indistinguishable colours.

The benefits of using the YUV pixel based algorithm of the invention have been confirmed through experiments involving 24 bit test images and comparisons between the results obtained and those using RGB truncation and YUV 4:2:2 algorithms.

From these experiments, certain notable conclusions can be drawn.

Firstly, it was clearly evident that utilisation of the YUV pixel based algorithm is successful in effectively meeting, and combining, the positive aspects of the other two algorithms. In this respect, the gradation of grey levels is found to be better than the RGB truncation algorithm and equivalent to the YUV 4:2:2 algorithm.

In respect of colour text, test images based on red blue and yellow text were found to be better in terms of display quality than the YUV 4:2:2 algorithm, and corresponding to that with the RGB truncation algorithm.

The memory 17 may be used to implement a variety of functions. These will be well known to those skilled in the art. No frame memory is required for continuous reception and transmission, but the memory allows additional image processing functions. By way of example, these include scrolling functions without the need to continuously receive data, and this may be attractive for small displays on portable devices. Full scrolling or scrolling of a partial area of the screen may be desired. Rotation, zoom and mirror functions can also be implemented, again without needing the data to be provided to the display device repeatedly.

The use of an internal memory can also provide power savings for the display of static images.

The invention can be used to receive and process RGB data or YUV data or indeed data in another format.

The example above uses averaging of pairs of pixels to determine new U and V values. These neighbouring pixels are typically in the row direction, so that the display area is divided into areas of two side-by-side pixels for the purposes of rendering the image. The neighbouring pixels may also be in the column direction.

In more complicated schemes, more complicated threshold calculations may be performed, and these may also operate on a larger group of pixels. Thus, there may be “a predetermined U difference criteria” and “a predetermined V difference criteria” which looks at the U and V values of a sub-array of pixels, and these sub-arrays may overlap in the manner of a dither function.

The threshold function may not simply compare U and V values, but may be more involved. For example, the U and V values may not be treated independently as in the examples above, but may be combined into an overall algorithm which determines when intermediate U and V values are to be derived from the 5 bit (or other size) U and V values extracted from the memory. In this case, the U and V criteria are embodied in a single algorithm, which determines if altered U and/or V data can be provided to multiple pixels in the group/sub-array.

The example above provides the sharing of new U and V pixel values between adjacent pixels. However, each U and V value may be determined independently. One example of alternative algorithm is shown in FIG. 3.

As shown, the data from the RAM 17 is again in the form of 8 bit Y data and 5 bit U and V data for each pixel.

Before processing the data, the 5 bit U and V data is converted to 8 bit data. A threshold function is again carried out for each pixel, but the pixels are not grouped into pairs in this example. Instead, a dither type function is implemented, in which the U and V data is determined by a comparison between the current pixel and a next pixel. Thus, for pixel 1, a comparison is made between the U data of pixel 1 and pixel 2, and if the difference exceeds a threshold, an average is taken, otherwise the 8 bit U data is unaltered. Similarly, a comparison is made between the V data of pixel 1 and pixel 2, and if the difference exceeds a threshold, an average is taken, otherwise the 8 bit V data is unaltered.

For pixel 2, a comparison is made between pixels 2 and 3, and so on. The pixels used in the comparisons may again be adjacent pixels in the row direction, and no averaging may take place for the last pixel in the row (as there is no “next” pixel). Again, more complicated groups of pixels may be processed, and this example simply demonstrates that the pixels do not need to be divided into discrete groups having self-contained processing.

The algorithm is essentially making an evaluation of what new 8 bit U and V data will best represent the original 8 bit U and V data, in particular the resolution that was lost when converting to 5 bits before data storage in the RAM. There are many other algorithms that can aim to do this, and simple examples have been given above for the purposes of clarity.

The selective averaging used in the examples above is one way to generate intermediate values which have a higher resolution than the original 5 bit data, but other extrapolation or best fit techniques may be used.

The invention can be applied to processes other than the driving of display devices, for example MPEG image processing.

The algorithms of the invention are implemented in software, for example implemented by the processor 8.

In the description and claims, the data for one pixel is to be considered “independent” of the pixel data for another pixel if pixel data values have not been combined. In other words, the stored pixel data values are derived only from the required display output for the corresponding area of the image to be displayed.

From the present disclosure, various modifications and variations will be apparent to persons skilled in the art. Such modifications and variations may involve other features which are already known in the fields of storing colour pixel data and display drivers and which may be used instead of or in addition to features already disclosed herein.

1. A method of storing colour pixel data, comprising:
providing the pixel data in YUV form with a first number of bits per colour component;
reducing the number of bits of the U and V components of each pixel data element to provide modified YUV data, wherein the reduction in the number of bits is carried out for each pixel without reference to other pixel data; and
storing the modified YUV data.

2. A method as claimed in claim 1, further comprising receiving pixel data elements in RGB form, and converting the pixel data elements into the YUV form.

3. A method as claimed in claim 2, where the RGB data has 8 bits per colour component per pixel.

4. A method as claimed in claim 3, wherein the modified YUV data has 5 bits for each of the U and V components and 8 bits for the Y component.

5. A method as claimed in claim 1, wherein storing the modified YUV data comprises storing the data in a RAM which forms part of the driver circuitry of a colour display device.

6. A method as claimed in claim 5, wherein the RAM forms part of an active matrix LCD driver circuit.

7. A method of driving a display, comprising:
reading pixel data from a memory in the form of YUV data, in which the Y component has a first number of bits, and the U and V components each have a second, lower, number of bits;
processing the U and V components of the pixels, and for each pixel of at least one group of pixels:
if the U component value of that pixel meets a predetermined U criteria which takes into account the U component value for at least one other pixel, deriving at least one new U component value to replace the U component value of the pixel, the new U component value having a higher resolution than said U component value of the pixel; and
if the V component value of that pixel meets a predetermined V criteria which takes into account the V component value for at least one other pixel, deriving at least one new V component value to replace the V component value of the pixel, the new V component value having a higher resolution than said V component value of the pixel;
converting the resulting YUV values into RGB pixel drive data; and
driving the display using the RGB pixel drive data.

8. A method as claimed in claim 7, wherein deriving the new U and V component values comprises deriving new U and V component values to be shared by at least two pixels in the group.

9. A method as claimed in claim 7, wherein the U and V component values are processed for a plurality of groups of pixels, each group of pixels comprising an adjacent pair of pixels.

10. A method as claimed in claim 8, wherein the predetermined U criteria is that the U component difference for the pair of pixels is below a threshold, in response to which an average U value is obtained for both pixels and the U component value for each pixel is replaced with the average U value.

11. A method as claimed in claim 10, wherein the predetermined V criteria is that the V component difference for the pair of pixels is below a threshold, in response to which an average V value is obtained for both pixels and the V component value for each pixel is replaced with the average V value.

12. A method as claimed in claim 7, wherein driving the display comprises applying gamma correction using the RGB pixel drive data.

13. A method as claimed in claim 7, wherein the first number is 8 and the second number is 5.

14. A method as claimed in claim 7, wherein reading pixel data comprises reading from a RAM (17) forming part of the display driver circuitry.

15. A driver arrangement for a display device comprising: driver circuitry for providing signals to row and column conductors of the display device for driving the display;
a memory for storing pixel data in the form of YUV data, in which the Y component has a first number of bits, and the U and V components each have a second, lower, number of bits, wherein the stored pixel data for each pixel is independent of the stored pixel data for each other pixel; and
a processor for deriving RGB pixel drive data from the stored pixel data.

16. An arrangement as claimed in claim 14, wherein the processor is adapted to implement a method of:
for each pixel of at least one group of pixels:
if the U component value of that pixel meets a predetermined U criteria which takes into account the U component value for at least one other pixel, deriving at least one new U component value to replace the U component value of the pixel, the new U component value having a higher resolution than said U component value of the pixel; and
if the V component value of that pixel meets a predetermined V criteria which takes into account the V component value for at least one other pixel, deriving at least one new V component value to replace the V component value of the pixel, the new V component value having a higher resolution than said V component value of the pixel; and
converting the resulting YUV values into RGB pixel drive data.

17. An arrangement as claimed in claim 16, wherein deriving the new U and V component values comprises deriving new U and V component values to be shared by at least two pixels in the group.

18. An arrangement as claimed in claim 17, wherein the U and V component values are processed for a plurality of groups of pixels, each group of pixels comprising an adjacent pair of pixels.

19. An arrangement as claimed in claim 18, wherein the predetermined U criteria is that the U component difference for the pair of pixels is below a threshold, in response to which an average U value is obtained for both pixels and the U component value for each pixel is replaced with the average U value.

20. An arrangement as claimed in claim 19, wherein the predetermined V criteria is that the V component difference for the pair of pixels is below a threshold, in response to which an average V value is obtained for both pixels and the V component value for each pixel is replaced with the average V value.

21. An arrangement as claimed in claim 16, wherein the processor is further adapted to apply gamma correction to the RGB pixel drive data.

22. An arrangement as claimed in claim 16, wherein the first number is 8 and the second number is 5.

23. A display device comprising a driver arrangement as claimed in claim 15, and an array of display pixels arranged in rows and columns.

24. A device as claimed in claim 23, comprising a liquid crystal display device.

25. A memory device which stores display device pixel data in the form of YUV data, in which the Y component has a first number of bits, and the U and V components each have a second, lower, number of bits, wherein the stored pixel data for each pixel is independent of the stored pixel data for each other pixel.

26. A computer program comprising code which when run on a computer is adapted to perform the method of claim 1.

27. A computer readable medium storing a computer program as claimed in claim 26.
